(19) United States
(12) Patent Application Publication
(10) Pub. No.: US 2026/0151724 A1
(43) Pub. Date: Jun. 4, 2026

(54) AIR PURIFIER AND AIR PURIFYING METHOD

(71) Applicants: Samsung Electronics Co., Ltd, Suwon-si (KR); INCHEON NATIONAL UNIVERSITY RESEARCH & BUSINESS FOUNDATION, Incheon (KR); Hongik University Industry-Academia Cooperation Foundation, Seoul (KR)

(72) Inventors: Joonseon JEONG, Suwon-si (KR); Dongjin LEE, Suwon-si (KR); Hyun Chul LEE, Suwon-si (KR)

(21) Appl. No.: 19/409,371

(22) Filed: Dec. 4, 2025

(30) Foreign Application Priority Data
Dec. 4, 2024 (KR) 10-2024-0178862

(51) Int. Cl. B01D 47/06; B01D 46/00; B01D 50/60

(52) U.S. Cl. CPC B01D 47/06; B01D 46/0031; B01D 46/0043; B01D 50/60

(57) ABSTRACT

An air purifier includes a duct along which air containing fine dust flows, a droplet spraying unit which sprays droplets into the duct to form a gas-liquid mixed fluid, a gas-liquid contact layer provided with a plurality of pores through which the gas-liquid mixed fluid passes, where the gas-liquid contact layer includes a first surface and a second surface, and the gas-liquid mixed fluid is introduced or discharged via the first and second surfaces, and an introduction surface changing member which changes an introduction surface of the gas-liquid contact layer, via which the gas-liquid mixed fluid is introduced in the gas-liquid contact layer, from one of the first and second surfaces to the other of the first and second surfaces.

### CROSS-REFERENCE TO RELATED APPLICATION

This application claims priority to Korean Patent Application No. 10-2024-0178862, filed on Dec. 4, 2024, and all the benefits accruing therefrom under 35 U.S.C. § 119, the content of which in its entirety is herein incorporated by reference.

### BACKGROUND

### 1. Field

The disclosure relates to an air purifier and an air purifying method, for removing pollutants from the air.

### 2. Description of the Related Art

An air purifier purifies air by collecting or decomposing gas, for example, pollutants including fine dust in the air. The air purifier may be used in industrial dust collection equipment, an air conditioning/ventilating system in a building, etc.

A filtering method is a representative method of removing fine dust from the air. A filtering method involves collecting fine dust included in the air by using a filter. A filtering method may have high dust removal efficiency and may filter dust in various forms from the air.

### SUMMARY

In a filtering method using a filter, as the amount of fine dust collected in the filter increases, the performance of the filter may degrade and a pressure drop due to the filter may increase. Accordingly, the filter may be desired to be periodically managed or replaced.

Embodiments of the disclosure provide an air purifier capable of suppressing a differential pressure rise due to accumulation of pollutants in a gas-liquid contact layer.

Embodiments of the disclosure provide an air purifying method to suppress a differential pressure rise due to accumulation of pollutants in a gas-liquid contact layer.

According to an embodiment of the disclosure, an air purifier includes a duct along which air containing fine dust flows, a droplet spraying unit which sprays droplets into the duct to form a gas-liquid mixed fluid, a gas-liquid contact layer provided with a plurality of pores through which the gas-liquid mixed fluid passes, where the gas-liquid contact layer includes a first surface and a second surface, and the gas-liquid mixed fluid is introduced or discharged via the first and second surfaces, and an introduction surface changing member which changes an introduction surface of the gas-liquid contact layer, via which the gas-liquid mixed fluid is introduced in the gas-liquid contact layer, from one of the first and second surfaces to the other of the first and second surfaces.

In an embodiment, the introduction surface changing member may periodically change a flow path of the gas-liquid mixed fluid.

In an embodiment, the introduction surface changing member may selectively provide a first flow path along which the gas-liquid mixed fluid is introduced via the first surface of the gas-liquid contact layer and is discharged via the second surface and a second flow path along which the gas-liquid mixed fluid is introduced via the second surface of the gas-liquid contact layer and is discharged via the first surface.

In an embodiment, the gas-liquid contact layer be provided in plural, and a plurality of gas-liquid contact layers may be arranged spaced apart from each other in a direction perpendicular to a direction of gravity.

In an embodiment, adjacent gas-liquid contact layers among the plurality of gas-liquid contact layers may be arranged in a way such that first surfaces of the adjacent gas-liquid contact layer face each other or second surfaces of the adjacent gas-liquid contact layer face each other, a first channel through which the gas-liquid mixed fluid is movable may be provided between the first surfaces of the adjacent gas-liquid contact layers, and a second channel through which the gas-liquid mixed fluid is movable may be provided between the second surfaces of the adjacent gas-liquid contact layers.

In an embodiment, the first channel and the second channel may be alternately arranged in the direction perpendicular to the direction of gravity.

In an embodiment, when the introduction surface changing member provides the first flow path, the introduction surface changing member may allow introduction of the gas-liquid mixed fluid through the first channel, block introduction of the gas-liquid mixed fluid through the second channel, allow discharge of the gas-liquid mixed fluid through the second channel, and block discharge of the gas-liquid mixed fluid through the first channel.

In an embodiment, when the introduction surface changing member provides the second flow path, the introduction surface changing member may allow introduction of the gas-liquid mixed fluid through the second channel, block introduction of the gas-liquid mixed fluid through the first channel, allow discharge of the gas-liquid mixed fluid through the first channel, and block discharge of the gas-liquid mixed fluid through the second channel.

In an embodiment, the introduction surface changing member may include a first channel blocking member arranged on an upstream side of the plurality of gas-liquid contact layers, where the first channel blocking member may selectively block an upstream side of the first channel or the second channel, and a second channel blocking member arranged on a downstream side of the plurality of gas-liquid contact layers, where the second channel blocking member may selectively block a downstream side of the first channel or the second channel.

In an embodiment, when the introduction surface changing member provides the first flow path, the first channel blocking member may open an upstream side of the first channel and block an upstream side of the second channel to allow introduction of the gas-liquid mixed fluid via the first surface and the second channel blocking member may block a downstream side of the first channel and open a downstream side of the second channel to allow discharge of the gas-liquid mixed fluid via the second surface.

In an embodiment, when the introduction surface changing member provides the second flow path, the first channel blocking member may block the upstream side of the first channel and open the upstream side of the second channel to allow introduction of the gas-liquid mixed fluid via the second surface and the second channel blocking member may open the downstream side of the first channel and block the downstream side of the second channel to allow discharge of the gas-liquid mixed fluid via the first surface.

In an embodiment, the first channel blocking member and the second channel blocking member may be movable in an arrangement direction of the plurality of gas-liquid contact layers.

In an embodiment, the first channel blocking member and the second channel blocking member may move in opposite directions to each other.

In an embodiment, the gas-liquid contact layer may include a porous foam member.

In an embodiment, a surface of the porous foam member may be hydrophobically or hydrophilically treated.

In an embodiment, the gas-liquid contact layer may include a housing and a plurality of filling particles filled inside the housing.

In an embodiment, the air purifier may further include a gas removing unit arranged on an upstream side of the droplet spraying unit to remove gaseous pollutants from the air.

According to another embodiment of the disclosure, an air purifying method of an air purifier which collects fine dust through a gas-liquid contact layer includes spraying droplets to air containing fine dust to form a gas-liquid mixed fluid, allowing the gas-liquid mixed fluid to move along a first flow path along which the gas-liquid mixed fluid is introduced via a first surface of the gas-liquid contact layer and is discharged via a second surface of the gas-liquid contact layer, to pass through the gas-liquid contact layer, changing an introduction surface of the gas-liquid contact layer, via which the gas-liquid mixed fluid is introduced in the gas-liquid contact layer, from the first surface to the second surface, and allowing the gas-liquid mixed fluid to move along a second flow path along which the gas-liquid mixed fluid is introduced via the second surface of the gas-liquid contact layer and is discharged via the first surface, to pass through the gas-liquid contact layer.

In an embodiment, the changing of the introduction surface may include moving a position of an introduction surface changing member to change the introduction surface of the gas-liquid contact layer from the first surface to the second surface.

In an embodiment, the gas-liquid contact layer may be provided in plural, and a plurality of gas-liquid contact layers may be arranged spaced apart from each other in a direction perpendicular to a direction of gravity, adjacent gas-liquid contact layers among the plurality of gas-liquid contact layers may be arranged in a way such that first surfaces of the adjacent gas-liquid contact layers face each other or second surfaces of the adjacent gas-liquid contact layers face each other, a first channel through which the gas-liquid mixed fluid is movable may be provided between the first surfaces of the adjacent gas-liquid contact layers, and a second channel through which the gas-liquid mixed fluid is movable may be provided between the second surfaces of the adjacent gas-liquid contact layers, and the introduction surface changing member may include a first channel blocking member arranged on an upstream side of the plurality of gas-liquid contact layers, where the first channel blocking member may selectively block an upstream side of the first channel or the second channel and a second channel blocking member arranged on a downstream side of the plurality of gas-liquid contact layers, where the second channel blocking member may selectively block a downstream side of the first channel or the second channel.

In an embodiment, when the gas-liquid mixed fluid moves along the first flow path, the first channel blocking member may open an upstream side of the first channel and block an upstream side of the second channel to allow introduction of the gas-liquid mixed fluid via the first surface and the second channel blocking member may block a downstream side of the first channel and open a downstream side of the second channel to allow discharge of the gas-liquid mixed fluid via the second surface.

In an embodiment, when the gas-liquid mixed fluid moves along the second flow path, the first channel blocking member may block the upstream side of the first channel and open the upstream side of the second channel to allow introduction of the gas-liquid mixed fluid via the second surface and the second channel blocking member may open the downstream side of the first channel and block the downstream side of the second channel to allow discharge of the gas-liquid mixed fluid via the first surface.

In an embodiment, the changing of the introduction surface may include the first channel blocking member and the second channel blocking member moving in an arrangement direction of the plurality of gas-liquid contact layers.

### BRIEF DESCRIPTION OF THE DRAWINGS

The above and other features of certain embodiments of the disclosure will be more apparent from the following description taken in conjunction with the accompanying drawings, in which:

FIG. 1 is a block diagram conceptually showing an air purifier according to an embodiment;

FIG. 2 is a schematic structural diagram of an example of the air purifier shown in FIG. 1;

FIGS. 3 and 4 are views for describing accumulation of pollutants in a gas-liquid contact layer of an air purifier according to an embodiment;

FIGS. 5 and 6 are views for describing an example of an introduction surface changing member of an air purifier according to an embodiment;

FIG. 7 is a view for describing a state in which a gas-liquid mixed fluid moves along a first flow path in an air purifier according to an embodiment;

FIG. 8 is a view for describing a state in which a gas-liquid mixed fluid moves along a second flow path in an air purifier according to an embodiment;

FIG. 9 is a view for describing another example of an introduction surface changing member of an air purifier according to an embodiment;

FIG. 10 is a view for describing an example in which there is a single gas-liquid contact layer in an air purifier according to an embodiment;

FIG. 11 shows an example of a gas-liquid contact layer according to an embodiment;

FIG. 12 shows another example of a gas-liquid contact layer according to an embodiment;

FIG. 13 is a schematic structural diagram of an example of an air purifier;

FIG. 14 is a graph for comparing differential pressure performance with respect to whether an introduction surface of a gas-liquid contact layer is changed;

FIG. 15 is a graph for comparing average particle removal efficiency with respect to whether an introduction surface of a gas-liquid contact layer is changed;

FIG. 16 is a graph for comparing quality factors with respect to whether an introduction surface of a gas-liquid contact layer is changed; and

FIG. 17 is a flowchart for describing an air purifying method of an air purifier according to an embodiment.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. Thus, reference to “an” element in a claim followed by reference to “the” element is inclusive of one element and a plurality of the elements. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

The term used herein such as “unit” or “module” indicates a unit for processing a function or operation, and may be implemented in hardware, software, or in a combination of hardware and software.

The use of the terms of “the above-described” and similar indicative terms may correspond to both the singular forms and the plural forms.

Also, operations constituting a method may be performed in any suitable order unless it is explicitly stated that they should be performed in an order they are described. Also, the use of all exemplary terms (for example, etc.) is only to describe technical spirit in detail, and the scope of rights is not limited by these terms unless limited by the claims.

Embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, embodiments of an air purifier and an air purifying method using the air purifier according to the disclosure will be described in detail with reference to the accompanying drawings. In the drawings, like reference numerals denote like components, and sizes of components in the drawings may be exaggerated for convenience of illustration and description.

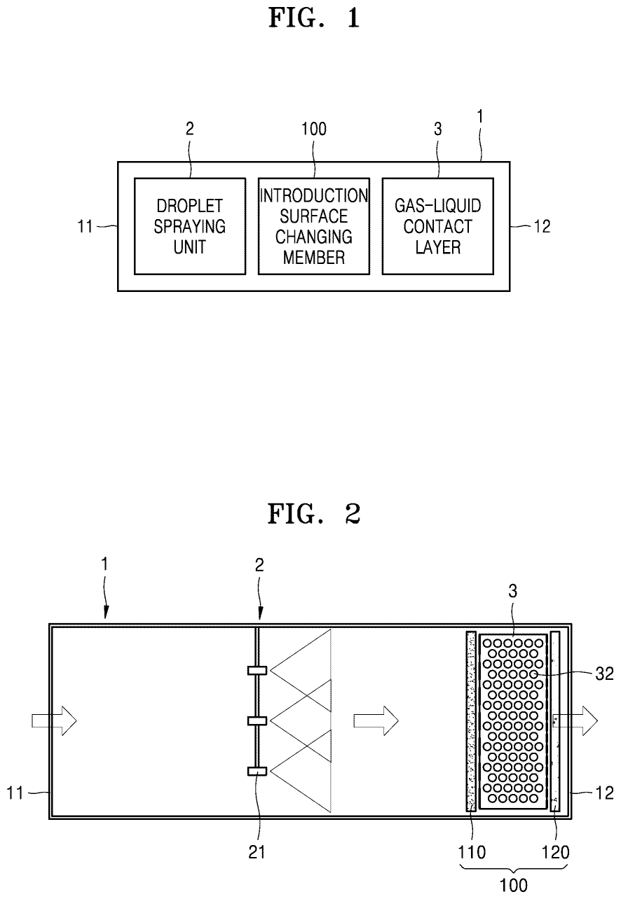

FIG. 1 is a block diagram conceptually showing an air purifier according to an embodiment, and FIG. 2 is a schematic structural diagram of an example of the air purifier shown in FIG. 1.

Referring to FIGS. 1 and 2, an embodiment of the air purifier may include a duct 1 through which air that is a purifying target flows, a droplet spraying unit 2 that sprays a fine droplet into the duct 1 to form a gas-liquid mixed fluid, and at least one gas-liquid contact layer 3 provided with a plurality of pores 32 through which the gas-liquid mixed fluid passes. The air that is subject to purification may include pollutants. The pollutants may include a particulate pollutant and gaseous pollutants. The gas-liquid contact layer 3 may be mainly used to remove the particulate pollutant and may be partially used to remove a water-soluble gaseous pollutant. Hereinbelow, the particulate pollutant will be referred to as fine dust.

The duct 1 may form an air flow path. A shape of the duct 1 is not specially limited. In some embodiments, a cross-sectional shape of the duct 1 may be various such as a circle, a polygon, etc. The cross-sectional shape of the duct 1 according to an embodiment may be a quadrangle. In some embodiments, air containing pollutants, e.g., fine dust, may be supplied to the duct 1 through an inlet 11 by a blower (not shown). The fine dust may include fine dust having a size (or diameter) of about 10 micrometers (μm) or less. The fine dust may include ultrafine dust having a size (or diameter) of about 2.5 μm or less. The air may move along the air flow path formed by the duct 1 and may be discharged from the duct 1 through an outlet 12.

In an embodiment of the air purifier, as shown in FIG. 2, the duct 1 may extend in a horizontal direction perpendicular to the gravity, and the inlet 11 and the outlet 12 may be positioned at a same height or level. However, the inlet 11 and the outlet 12 of the duct 1 of the air purifier may be positioned at the same height, and an extending direction, a shape, etc., of the duct 1 may be variously modified.

The droplet spraying unit 2 may spray droplets, e.g., water, into the duct 1. The droplet spraying unit 2 may include a spraying nozzle 21. In some embodiments, the spraying nozzle 21 may be provided in plural, i.e., the droplet spraying unit 2 may include a plurality of spraying nozzles 21. Droplets may be sprayed from the plurality of spraying nozzles 21 into the duct 1. However, a structure of the droplet spraying unit 2 is not limited thereto and may be various. In some embodiments, the droplet spraying unit 2 may include an ultrasonic vibrator.

In the duct 1, a gas-liquid mixed fluid, in which air and fine droplets are mixed with each other, may be formed. In this process, a part of the fine dust contained in the air may be collected and coarsened by the fine droplets. The gas-liquid mixed fluid may flow from the inlet 11 toward the outlet 12 along the air flow path in the duct 1.

Although not shown, a gas-liquid mixing device for inducing mixing of the air and the fine droplets may be arranged around the droplet spraying unit 2. However, the gas-liquid mixing device may be a selective component and may be omitted if desired.

The gas-liquid contact layer 3 may be provided with a plurality of pores 32, that is, the plurality of pores 32 are defined in the gas-liquid contact layer 3. A collection surface may be formed or defined on the gas-liquid contact layer 3 by the plurality of pores 32. The plurality of pores 32 may form a fine flow path through which the gas-liquid mixed fluid passes. In some embodiments, the gas-liquid mixed fluid may pass through the gas-liquid contact layer 3 through the plurality of pores 32. The fine dust collected and coarsened by the fine droplets while passing through the plurality of pores 32 may collide with and may be attached to the collection surface. Some of the fine droplets not including the fine dust may collide with and may be attached to the collection surface. A liquid film may be formed on the collection surface by the fine droplets. The fine dust not collected in the fine droplets may be collected in the liquid film formed on the collection surface in contact with the liquid film, while passing through the plurality of pores 32. Liquid forming the liquid film may flow down along the collection surface by, for example, the gravity. The fine dust collected in the droplets may be discharged together with the liquid outside the duct 1. The fine flow path may not extend linearly in a flowing direction of the gas-liquid mixed fluid. As the fine flow path is formed tortuously, a contact area between the collection surface of the fine flow path and the droplets increases, thereby facilitating collection of the droplets on the collection surface of the fine flow path.

In an embodiment, as described above, most of the fine dust may be collected on the liquid film formed on the collection surface of the gas-liquid contact layer 3 and flow down in the direction of gravity, thus being discharged outside the duct 1. However, a part of the fine dust may remain in the gas-liquid contact layer 3 and may be accumulated on the collection surface of the gas-liquid contact layer 3.

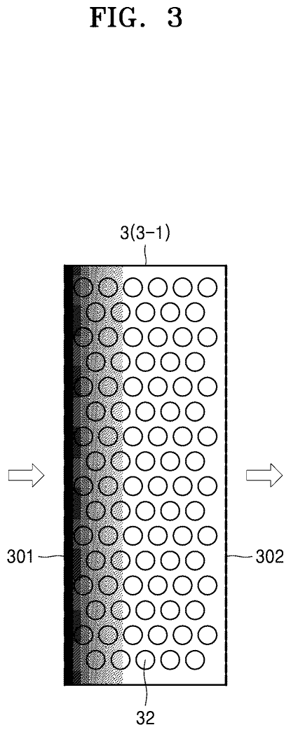

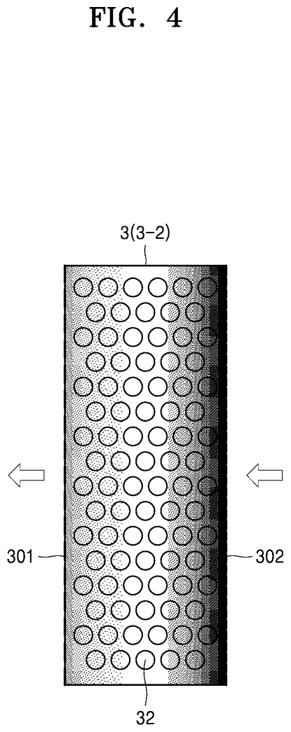

FIGS. 3 and 4 are views for describing accumulation of pollutants in the gas-liquid contact layer 3 of the air purifier according to an embodiment. In FIGS. 3 and 4, a moving direction of the gas-liquid mixed fluid is indicated by arrows.

Referring to FIG. 3, the gas-liquid contact layer 3 may include a first surface 301 and a second surface 302 via which the gas-liquid mixed fluid may be introduced or discharged. In an embodiment, for example, the gas-liquid mixed fluid may be introduced via the first surface 301 of the gas-liquid contact layer 3 and may be discharged via the second surface 302.

However, when the gas-liquid mixed fluid is continuously introduced via the first surface 301 of the gas-liquid contact layer 3, particles of pollutants such as fine dust may begin to be accumulated from the first surface 301 of the gas-liquid contact layer 3. When the gas-liquid mixed fluid is introduced via the first surface 301 of the gas-liquid contact layer 3, the particles of the fine dust may be gradually accumulated inside the gas-liquid contact layer 3, such that a pressure drop may occur while the gas-liquid mixed fluid passing through the gas-liquid contact layer 3. A pressure drop amount may be a difference between a pressure on an upstream side of and a pressure on a downstream side of the gas-liquid contact layer 3, and may also be referred to as a differential pressure. As the differential pressure increases, the energy efficiency of the air purifier may be degraded, thereby increasing driving (or operation) cost.

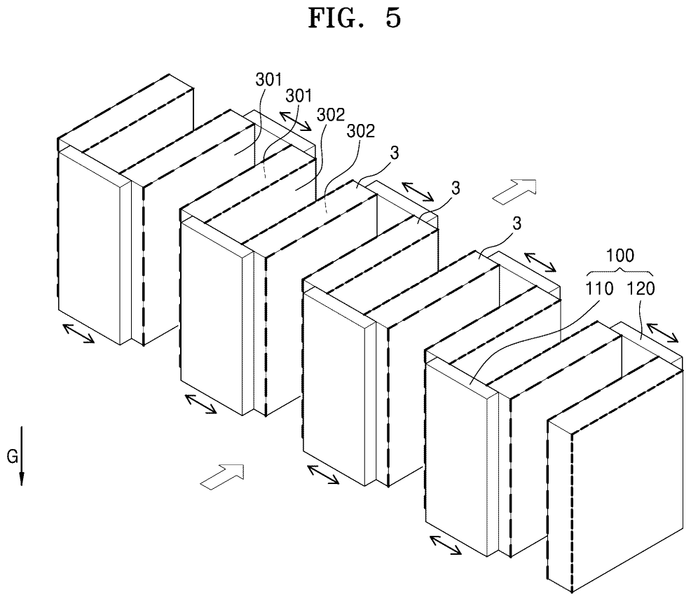

The air purifier according to an embodiment may include an introduction surface changing member 100 (see FIG. 5) that changes an introduction surface on which the fluid is introduced to the gas-liquid contact layer 3 to suppress accumulation of the pollutant on a gas-liquid mixed layer. The introduction surface of the gas-liquid contact layer 3 may be changed by the introduction surface changing member 100.

Referring to FIGS. 3 and 4, the gas-liquid contact layer 3 of the air purifier according to an embodiment may have a first state (3-1 in FIG. 3) in which the gas-liquid mixed fluid is introduced via the first surface 301 and a second state (3-2 in FIG. 4) in which the gas-liquid mixed fluid is introduced via the second surface 302. The first surface 301 may be the introduction surface when the gas-liquid contact layer 3 is in the first state 3-1, and the second surface 302 may be the introduction surface when the gas-liquid contact layer 3 is in the second state 3-2.

When the gas-liquid contact layer 3 is in the first state 3-1, the gas-liquid mixed fluid may be introduced via the first surface 301 and may be discharged via the second surface 302, and pollutants may be accumulated from the first surface 301, as shown in FIG. 3.

When the gas-liquid contact layer 3 is changed from the first state 3-1 to the second state 3-2, the gas-liquid mixed fluid may be introduced via the second surface 302 and discharged via the first surface 301, as shown in FIG. 4. As the gas-liquid mixed fluid is introduced via the second surface 302 of the gas-liquid contact layer 3, pollutants may be accumulated from the second surface 302. As the gas-liquid mixed fluid is discharged via the first surface 301, at least a part of the pollutant accumulated on the first surface 301 may be removed by the discharged gas-liquid mixed fluid when the gas-liquid contact layer 3 is in the first state 3-1.

When the gas-liquid contact layer 3 is changed from the second state 3-2 to the first state 3-1, the gas-liquid mixed fluid may be introduced via the first surface 301 and discharged via the second surface 302, as shown in FIG. 3. As the gas-liquid mixed fluid is introduced via the first surface 301 of the gas-liquid contact layer 3, pollutants may be accumulated from the first surface 301. As the gas-liquid mixed fluid is discharged via the second surface 302, at least a part of the pollutant accumulated on the second surface 302 may be removed by the discharged gas-liquid mixed fluid when the gas-liquid contact layer 3 is in the second state 3-2.

In an embodiment, as described above, as the introduction surface of the gas-liquid contact layer 3 for the gas-liquid mixed fluid is changed, the pollutant accumulated on a discharge surface arranged opposite to the introduction surface in the gas-liquid contact layer 3 may be removed. In such an embodiment, it is possible to suppress accumulation of the pollutant on the gas-liquid contact layer 3 to the extent exceeding a limit range, and to suppress an excessive differential pressure increase due to the gas-liquid contact layer 3. Thus, the energy efficiency of the air purifier may be improved.

In an embodiment, for example, the introduction surface changing member 100 may be configured to periodically change a path of the gas-liquid mixed fluid in a way such that the introduction surface of the gas-liquid contact layer 3 is changed.

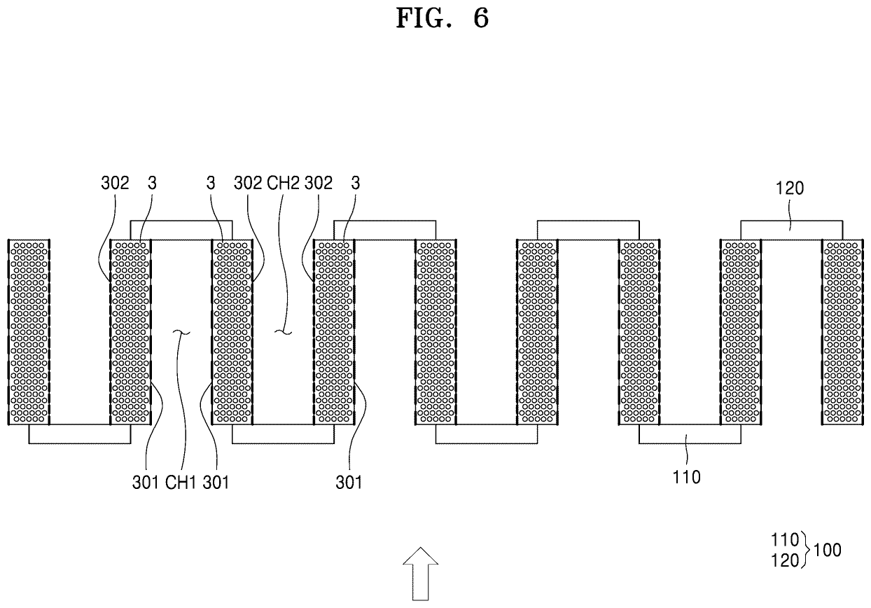

FIGS. 5 and 6 are views for describing an example of the introduction surface changing member 100 of an air purifier according to an embodiment. FIG. 6 is a cross-sectional view in which the gas-liquid contact layer 3 and the introduction surface changing member 100 of FIG. 5 are cut in a direction perpendicular to the gravity. In FIGS. 5 and 6, the first surface 301 and the second surface 302 are indicated by different dotted lines for distinguishment therebetween, but the first surface 301 and the second surface 302 may have different positions, but have a same surface property.

Referring to FIGS. 5 and 6, the air purifier according to an embodiment may include a plurality of gas-liquid contact layers 3. The plurality of gas-liquid contact layers 3 may be arranged to be spaced apart from each other in a direction perpendicular to a direction of gravity G. A supply direction of the gas-liquid mixed fluid may be perpendicular to the direction of gravity G and an arrangement direction of the plurality of gas-liquid contact layers 3.

Each of the plurality of gas-liquid contact layers 3 may include the first surface 301 and the second surface 302 via which the gas-liquid mixed fluid may be introduced or discharged. Each of the plurality of gas-liquid contact layers 3 may include the first surface 301 and the second surface 302 that are opened to allow the gas-liquid mixed fluid to be introduced via the first surface 301 or the second surface 302, and the remaining surfaces of the each of the plurality of gas-liquid contact layers other than the first surface 301 and the second surface 302 may be closed to prevent the gas-liquid contact layer from being introduced or discharged therethrough. In an embodiment, at least a part of a bottom surface of each of the plurality of gas-liquid contact layers 3 may be opened to allow liquid containing the fine dust from flowing out by the gravity.

Adjacent gas-liquid contact layers 3 among the plurality of gas-liquid contact layers 3 may be arranged to face each other in an arrangement direction of the plurality of gas-liquid contact layers 3. The adjacent gas-liquid contact layers 3 may be arranged in a way that the first surfaces 301 face each other or the second surfaces 302 face each other. In an embodiment, for example, the first surface 301 of a gas-liquid contact layer 3 may be arranged to face the first surface 301 of an adjacent gas-liquid contact layer 3. The second surface 302 of the gas-liquid contact layer 3 may be arranged to face the second surface 302 of another adjacent gas-liquid contact layer 3.

A channel may be provided between the plurality of gas-liquid contact layers 3 to allow movement of the gas-liquid mixed fluid. A first channel CH1 may be provided by the first surfaces 301 of the adjacent gas-liquid contact layers 3, and a second channel CH2 may be provided by the second surfaces 302 of the adjacent gas-liquid contact layers 3. The first channel CH1 and the second channel CH2 may be alternately arranged in the arrangement direction of the plurality of gas-liquid contact layers 3.

The introduction surface changing member 100 may selectively provide a first flow path P1 along which the gas-liquid mixed fluid moves from the first surface 301 of the gas-liquid contact layer 3 toward the second surface 302 and a second flow path P2 along which the gas-liquid mixed fluid moves from the second surface 302 of the gas-liquid contact layer 3 toward the first surface 301.

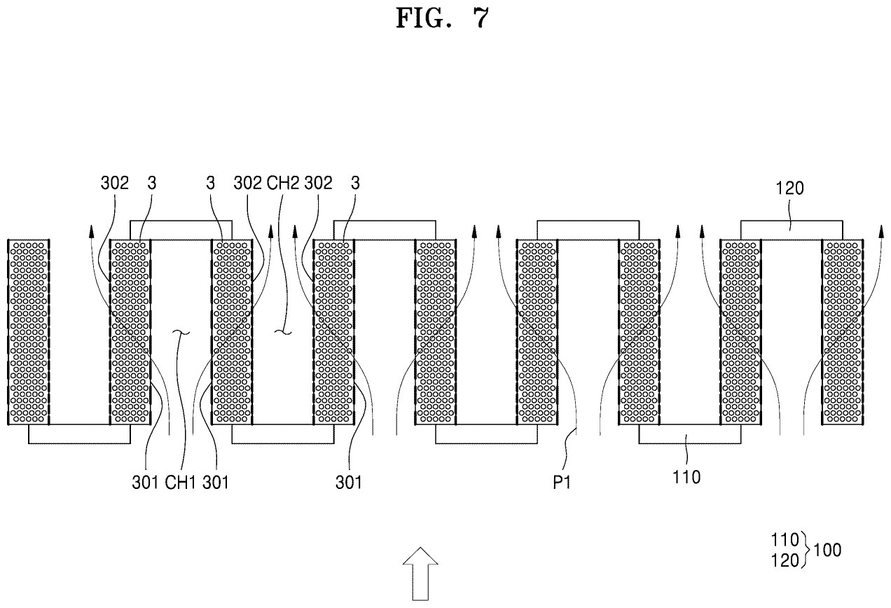

When the introduction surface changing member 100 provides the first flow path P1 (see FIG. 7), the introduction surface changing member 100 may allow introduction of the gas-liquid mixed fluid through the first channel CH1 and block introduction of the gas-liquid mixed fluid through the second channel CH2. The introduction surface changing member 100 may allow discharge of the gas-liquid mixed fluid through the second channel CH2 and block discharge of the gas-liquid mixed fluid through the first channel CH1.

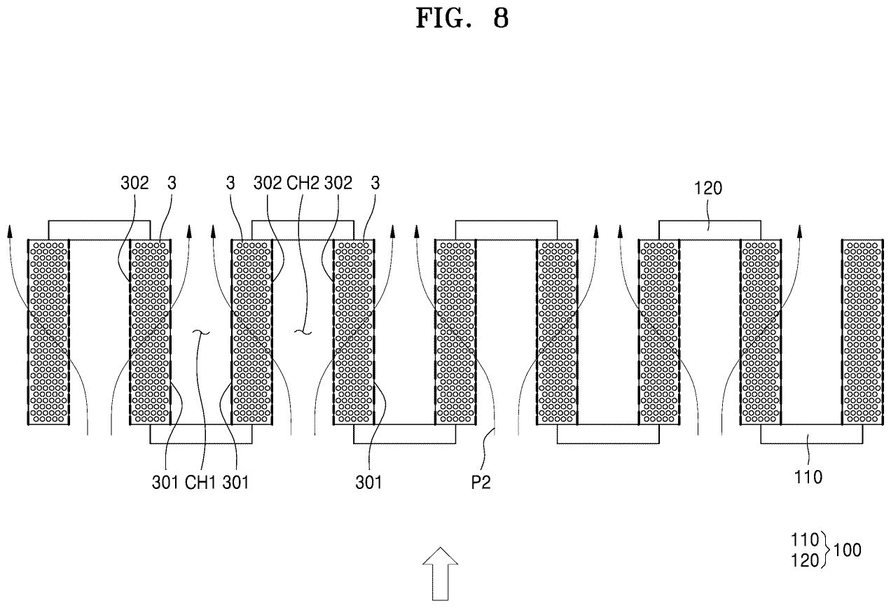

When the introduction surface changing member 100 provides the second flow path P2 (see FIG. 8), the introduction surface changing member 100 may allow introduction of the gas-liquid mixed fluid through the second channel CH2 and block introduction of the gas-liquid mixed fluid through the first channel CH1. The introduction surface changing member 100 may allow discharge of the gas-liquid mixed fluid through the first channel CH1 and block discharge of the gas-liquid mixed fluid through the second channel CH2.

In some embodiments, the introduction surface changing member 100 may include a first channel blocking member 110 arranged on an upstream side of the plurality of gas-liquid contact layers 3 and a second channel blocking member 120 arranged on a downstream side of the plurality of gas-liquid contact layers 3.

The first channel blocking member 110 may selectively block an upstream side (or upstream side opening) of the first channel CH1 or the second channel CH2. The second channel blocking member 120 may selectively block a downstream side (or downstream side opening) of the first channel CH1 or the second channel CH2. Herein, the upstream side and the downstream side may be defined as those in the supply direction (or the direction of flow) of the gas-liquid mixed fluid.

The first channel blocking member 110 may allow introduction of the gas-liquid mixed fluid through any one of the first channel CH1 or the second channel CH2. The second channel blocking member 120 may allow discharge of the gas-liquid mixed fluid through any one of the first channel CH1 or the second channel CH2. The first channel blocking member 110 and the second channel blocking member 120 may be positioned not to overlap each other in a channel extending direction.

In some embodiments, when the first channel blocking member 110 blocks the upstream side of the first channel CH1, the second channel blocking member 120 may block the downstream side of the second channel CH2. In some embodiments, when the first channel blocking member 110 blocks the upstream side of the second channel CH2, the second channel blocking member 120 may block the downstream side of the first channel CH1.

In such an embodiment, the first channel blocking member 110 and the second channel blocking member 120 may be configured to be movable in the arrangement direction of the plurality of gas-liquid contact layers 3. The first channel blocking member 110 and the second channel blocking member 120 may move in opposite directions to each other. In some embodiments, when the first channel blocking member 110 moves to the right, the second channel blocking member 110 may move to the left. In some embodiments, when the first channel blocking member 110 moves to the left, the second channel blocking member 110 may move to the right.

FIG. 7 is a view for describing a state in which a gas-liquid mixed fluid moves along the first flow path P1 in the air purifier according to an embodiment, and FIG. 8 is a view for describing a state in which a gas-liquid mixed fluid moves along the second flow path P2 in the air purifier according to an embodiment.

Referring to FIG. 7, in an embodiment, the introduction surface changing member 100 may provide the first flow path P1 or to allow the first flow path P1 to open. The introduction surface changing member 100 may allow introduction of the gas-liquid mixed fluid through the first channel CH1 and block introduction of the gas-liquid mixed fluid through the second channel CH2. The introduction surface changing member 100 may block discharge of the gas-liquid mixed fluid, introduced through the first channel CH1, through the first channel CH1 and allow discharge of the introduction surface changing member through the second channel CH2.

In some embodiments, the first channel blocking member 110 may open the upstream side of the first channel CH1 and block the upstream side of the second channel CH2. To allow the gas-liquid mixed fluid to be discharged via the second surface 302 of the gas-liquid contact layer 3, the second channel blocking member 120 may block the downstream side of the first channel CH1 and open the downstream side of the second channel CH2.

As the upstream side of the first channel CH1 is opened by the first channel blocking member 110 and the downstream side of the first channel CH1 is blocked by the second channel blocking member 120, the gas-liquid mixed fluid may move to the upstream side of the first channel CH1 and thus may be introduced via the first surface 301 of the gas-liquid contact layer 3.

The gas-liquid mixed fluid introduced via the first surface 301 may be discharged via the second surface 302 through the second channel CH2. As the downstream side of the second channel CH2 is opened, the gas-liquid mixed fluid discharged through the second channel CH2 may be discharged through the downstream side of the second channel CH2.

Referring to FIG. 8, the introduction surface changing member 100 may move to change the flow path of the gas-liquid mixed fluid. The introduction surface changing member 100 may move to provide the second flow path P2 to allow the second flow path P2 to open.

In some embodiments, the first channel blocking member 110 and the second channel blocking member 120 may move in the arrangement direction of the plurality of gas-liquid contact layers 3. The first channel blocking member 110 and the second channel blocking member 120 may move in opposite directions to each other. In some embodiments, the first channel blocking member 110 may move to the right, and the second channel blocking member 110 may move to the left. However, the moving directions of the first channel blocking member 110 and the second channel blocking member 120 are examples, and thus may be various modified.

The first channel blocking member 110 may be positioned to block the upstream side of the first channel CH1, and the second channel blocking member 120 may be positioned to block the downstream side of the second channel CH2.

As the upstream side of the first channel CH1 is blocked and the upstream side of the second channel CH2 is opened by the first channel blocking member 110, the gas-liquid mixed fluid may be introduced through the second channel CH2. The gas-liquid mixed fluid introduced through the second channel CH2 may move via the gas-liquid contact layer 3 through the first channel CH1 as the downstream side of the second channel CH2 is blocked by the second channel blocking member 120. The gas-liquid mixed fluid may be introduced via the second surface 302 and discharged via the first surface 301 and thus pass through the gas-liquid contact layer 3. The gas-liquid mixed fluid moving through the first channel CH1 may be discharged through the downstream side of the first channel CH1.

In such an embodiment as described above, the introduction surface changing member 100 may change the flow path of the gas-liquid mixed fluid by moving the first channel blocking member 110 and the second channel blocking member 120. The introduction surface changing member 100 may periodically change the flow path of the gas-liquid mixed fluid.

In some embodiments, based on the amount of pollutants accumulated in the gas-liquid contact layer 3, the introduction surface changing member 100 may change the flow path of the gas-liquid mixed fluid every specific time. In some embodiments, the introduction surface changing member 100 may change the flow path of the gas-liquid mixed fluid at intervals of several tens of minutes to several hundreds of minutes. In some embodiments, the introduction surface changing member 100 may change the flow path of the gas-liquid mixed fluid at intervals of about 20 minutes to about 40 minutes.

In the above-described embodiment, a structure is illustrated in which the introduction surface changing member 100 includes the first channel blocking member and the second channel blocking member that are movable in the arrangement direction of the plurality of gas-liquid contact layers 3. However, the structure and the moving direction of the introduction surface changing member 100 are not limited thereto and may be various.

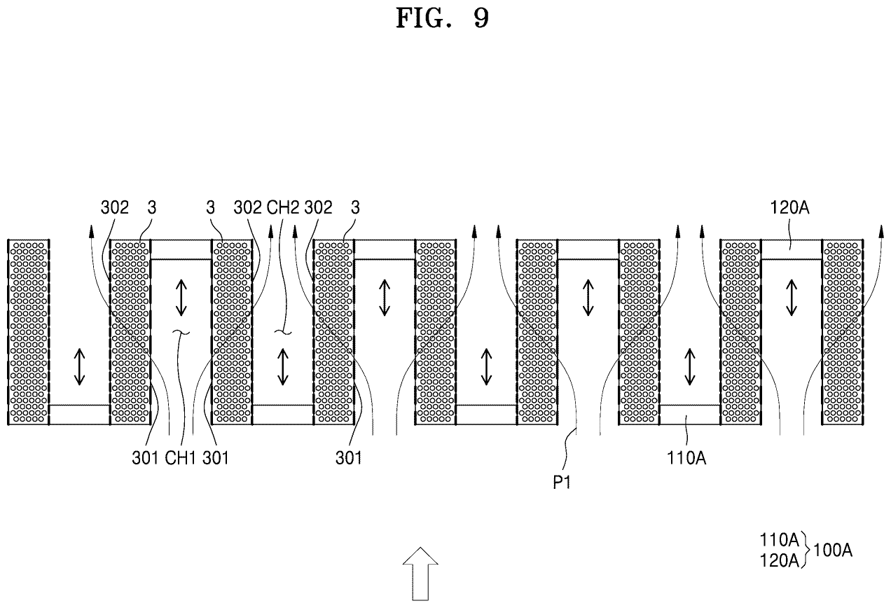

In some embodiments, as shown in FIG. 9, an introduction surface changing member 100A may include a first channel blocking member 110A arranged in the first channel CH1 and a second channel blocking member 120A arranged in the second channel CH2 in which the first channel blocking member 110A and the second channel blocking member 120A may move back and forth in the channel extending direction. The first channel blocking member 110A and the second channel blocking member 120A may move in opposite directions to each other along the channel extending direction. When the first channel blocking member 110A blocks the upstream side of the first channel CH1, the second channel blocking member 120A may block the downstream side of the second channel CH2. When the first channel blocking member 110A blocks the downstream side of the first channel CH1, the second channel blocking member 120A may block the upstream side of the second channel CH2. Although not shown, in some embodiments, the first channel blocking member 110A and the second channel blocking member 120A may move up and down in parallel to the direction of gravity G.

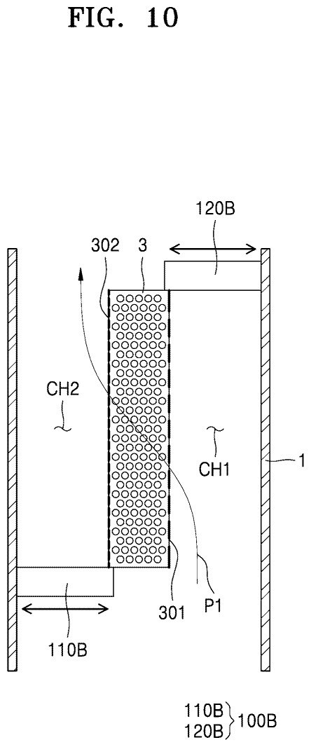

In embodiments, as described above, there are a plurality of gas-liquid contact layers 3 in the air purifier, but the present disclosure is not necessarily limited thereto. In some embodiments, there may be a single gas-liquid contact layer 3. In some embodiments, as shown in FIG. 10, the single gas-liquid contact layer 3 may be arranged inside the duct 1, in which the first channel CH1 may be formed by an inner surface of the duct 1 and the first surface 301 and the second channel CH2 may be formed by the inner surface of the duct 1 and the second surface 302. An introduction surface changing member 100B may include a first channel blocking member 110B that blocks the upstream side of one of the first channel CH1 and the second channel CH2 and a second channel blocking member 120B that blocks the downstream side of the other of the first channel CH1 and the second channel CH2.

In embodiments, as described above, the position of the gas-liquid contact layer 3 may be fixed in the air purifier, and the introduction surface changing members 100, 100A, or 100B may be channel blocking members that move relatively with respect to the gas-liquid contact layer 3. However, the introduction surface changing members 100, 100A, and 100B are not necessarily limited thereto, and may be changed variously. In some embodiments, although not shown, the introduction surface changing member 100 may be configured to rotate the gas-liquid contact layer 3 in a way that arrangement of the first surface 301 and the second surface 302 of the gas-liquid contact layer 3 is changed.

A structure of the gas-liquid contact layer 3 in which the introduction surface is changed by the introduction surface changing member 100 is not specially limited as long as a fine flow path is formed in the gas-liquid contact layer 3.

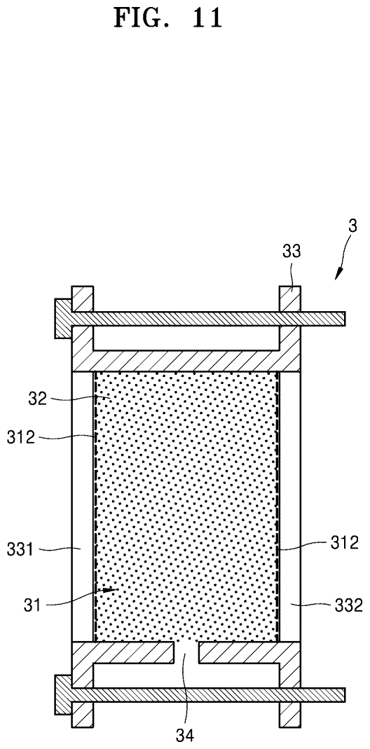

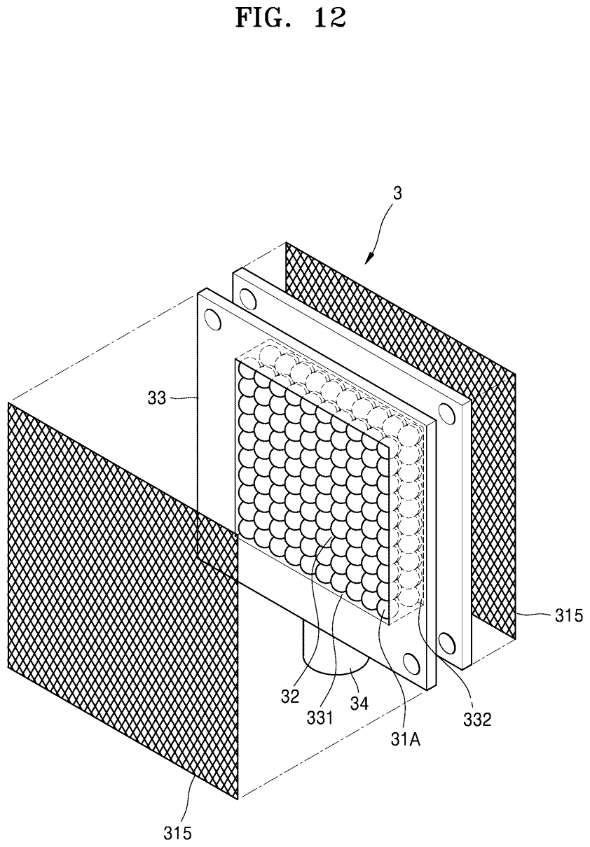

FIG. 11 shows an example of a gas-liquid contact layer according to an embodiment, and FIG. 12 shows another example of a gas-liquid contact layer according to an embodiment.

Referring to FIG. 11, in an embodiment, the gas-liquid contact layer 3 may include a porous foam member 31. The gas-liquid contact layer 3 may include the porous foam member 31 provided with the plurality of pores 32. The porous foam member 31 may include, for example, a metal foam block, e.g., a nickel foam block.

The surface of the porous foam member 31 may be treated to have non-affinity with respect to droplets such that the droplets may be easily separated from the surface of the porous foam member 31. In some embodiments, the surface of the porous foam member 31 may be hydrophobically treated. However, the surface of the porous foam member 31 is not limited thereto, and may be variously modified. In some embodiments, the surface of the porous foam member 31 may be treated to have affinity with respect to the droplets. In some embodiments, the surface of the porous foam member 31 may be hydrophilically treated. In other words, the surface of the porous foam member 31 may be hydrophobically or hydrophilically treated.

The porous foam member 31 may be accommodated in, for example, the housing 33. The housing 33 may define a first opening 331 and a second opening 332 structured to allow introduction or discharge of the gas-liquid contact layer via the first surface 301 or the second surface 302 of the gas-liquid contact layer 3. The first surface 301 of the gas-liquid contact layer 3 may be exposed through the first opening 331, and the second surface 302 may be exposed through the second opening 332. A side surface of the gas-liquid contact layer 3 may be blocked by the housing 22.

As the gas-liquid mixed fluid moves along the first flow path P1, the gas-liquid mixed fluid may be introduced into the housing 33 through the first opening 331, and may be discharged through the second opening 332 via the fine flow path formed by the plurality of pores 32 of the porous foam member 31. In this process, a liquid film may be formed on the collection surface of the fine flow path and the droplets containing the fine dust may be collected by the liquid film. The droplets may drop in the direction of gravity G and may be discharged through an outlet 34.

Referring to FIG. 12, the gas-liquid contact layer 3 may include a plurality of filling particles 31A packed inside the housing 33. A fine flow path may be formed by the pores 32 between the plurality of filling particles 31A. The surface of the plurality of filling particles 31A may form a collection surface on which a liquid film is formed and which collects fine dust. In the housing 33 may be provided the outlet 34 through which liquid collected on the surface of the plurality of filling particles 31A and the fine dust are discharged. The housing 33 may include a first opening 331 and a second opening 332 through which the gas-liquid mixed fluid containing the droplets is introduced or discharged.

The gas-liquid mixed fluid may pass through the pores 32 formed between the plurality of filling particles 31A. In this process, the droplets may be collected on the surface of the filling particles 31A. The droplets may drop in the direction of gravity G.

The surface of the filling particles 31A may be treated to have non-affinity with respect to droplets such that the droplets may be easily separated from the surface of the filling particles 31A. In some embodiments, the surface of the filling particles 31A may be hydrophobically treated. However, the surface of the filling particles 31A is not limited thereto, and may be variously modified. In some embodiments, the surface of the filling particles 31A may be treated to have affinity with respect to the droplets. In some embodiments, the surface of the filling particles 31A may be hydrophilically treated. In other words, the surface of the filling particles 31A may be hydrophobically or hydrophilically treated.

In an embodiment, a mesh screen 315 may be arranged on each of the first opening 331 and the second opening 332 of the housing 33. In such an embodiment, the plurality of filling particles 31A may be positioned between a pair of mesh screens 315. The mesh screen 315 may be treated (e.g., hydrophobically treated) to have non-affinity with respect to liquid. Thus, the pores 32 of the mesh screen 315 may not be blocked by liquid and a differential pressure may be reduced. The mesh screen 315 may be, for example, a metal mesh screen.

The air introduced to the duct 1 may include not only a particulate pollutant such as fine dust, etc., but also gaseous pollutants such as a harmful gas such as a water-soluble organic compound (VOCₛₒₗ), a water-insoluble organic compound (VOCᵢₙₛₒₗ), and other harmful gases. For example, the PM may include a small PM of about 10 μm or less and ultrafine dust of about 2.5 μm or less. Moreover, the water-soluble organic compound VOCₛₒₗ, which is a volatile organic compound, may include a gas material removable by being collected in water or an aqueous solution, e.g., ammonia (NH₃), acetaldehyde (CH₃CHO), and acetic acid (CH₃COOH). The water-insoluble organic compound VOCᵢₙₛₒₗ, which is a volatile organic compound not collected in water or an aqueous solution, may include, for example, benzene (C₆H₆), formaldehyde (CH₂O), toluene (C₆H₅CH₃), etc. However, the present disclosure is not limited thereto, and the air introduced to the duct 1 may include other random gases other than the fine dust, the water-soluble organic compound (VOCₛₒₗ), and the water-insoluble organic compound (VOCᵢₙₛₒₗ).

The particulate pollutant containing the fine dust may be removed by the droplet spraying unit 2 and the gas-liquid contact layer 3. The air purifier may include a structure for removing gaseous pollutants such as the water-soluble organic compound (VOCₛₒₗ), and the water-insoluble organic compound (VOCᵢₙₛₒₗ), etc.

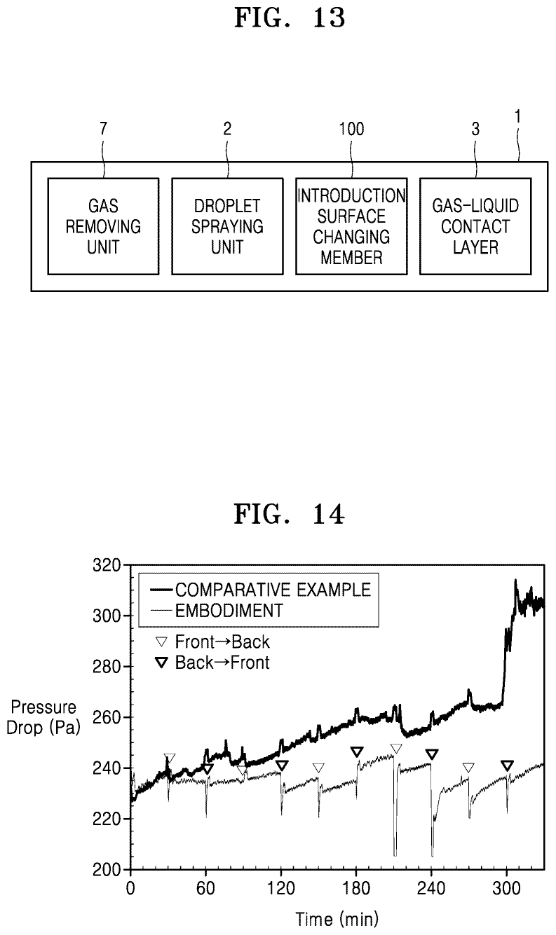

FIG. 13 is a schematic structural diagram of an example of the air purifier. The air purifier shown in FIG. 13 is substantially the same as the above-described embodiments of the air purifier except that the air purifier further includes a gas removing unit 7. Thus, the above-described components will be indicated by the same reference numeral, any repetitive detailed description of the same or like elements as those described above will be omitted, and a difference will be mainly described.

Referring to FIG. 13, an embodiment of the air purifier may further include the gas removing unit 7 that removes gaseous pollutants in the air. The gas removing unit 7 may be arranged on the upstream side of the droplet spraying unit 2. The gas removing unit 7 may be arranged inside the duct 1, and may be arranged on the upstream side of the inlet 11 of the duct 1 to supply the air having the gaseous pollutant removed therefrom into the duct 1 through the inlet 11 of the duct 1.

In an embodiment, the gas removing unit 7 may decompose and remove the gaseous pollutant by using plasma discharging. In an embodiment, the gas removing unit 7 may decompose and remove the gaseous pollutant by using photocatalytic reaction.

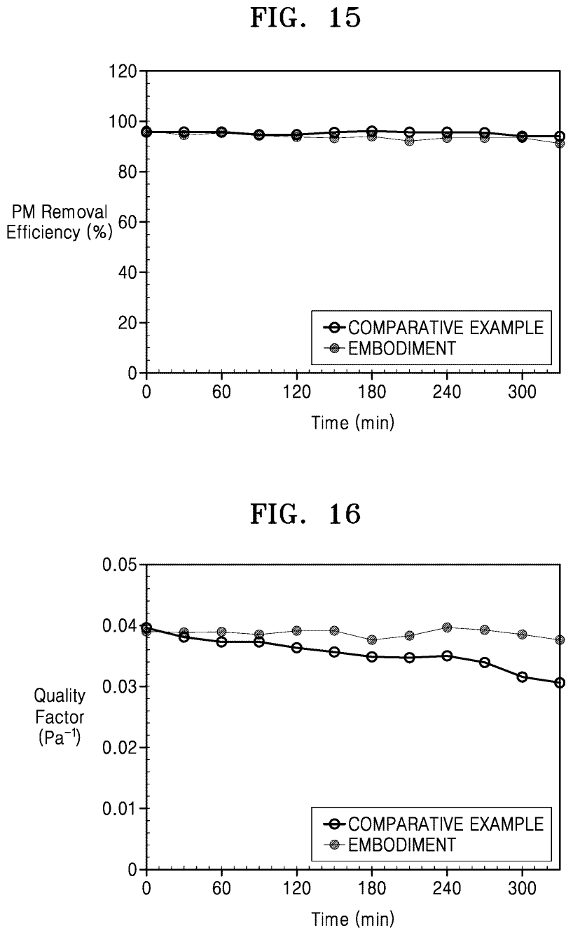

FIG. 14 is a graph for comparing differential pressure performance with respect to whether an introduction surface of the gas-liquid contact layer 3 is changed. FIG. 15 is a graph for comparing average particle removal efficiency with respect to whether an introduction surface of the gas-liquid contact layer 3 is changed. FIG. 16 is a graph for comparing quality factors with respect to whether an introduction surface of the gas-liquid contact layer 3 is changed.

For measurement, a nickel foam block having a size of 5 centimeters (cm)×5 cm, a thickness of 6 millimeters (mm) and the pores 32 of a size of 50 pore per inch (ppi) may be installed as the gas-liquid contact layer 3. A twin-fluid nozzle 21 may be employed as the droplet spraying unit 2, and may spray a water of 17 milliliter per minute (mL/min) and the air of 0.6 bar. Long drive results are compared for an embodiment where the introduction surface is changed by alternately applying front and back surfaces of the gas-liquid contact layer 3 at 30-minute intervals and a comparative example where the introduction surface is not changed without alternately applying the gas-liquid contact layer 3, while the air containing Arizona A1 dust 50 milligram per cubit meter (mg/m³) to 60 mg/m³ is supplied at a speed of 2.5 meter per second (m/s).

Referring to FIG. 14, when the introduction surface of the gas-liquid contact layer 3 is not changed as in the comparative example, the differential pressure increases over time and sharply increases from about 300 minutes. As in the embodiment, when the introduction surface of the gas-liquid contact layer 3 is periodically changed, the differential pressure does not sharply increase over time. When the introduction surface of the gas-liquid contact layer 3 is changed, the differential pressure is maintained constant within a selected range without sharply increasing, which may mean that the fine dust accumulated on a discharge surface that is opposite to the introduction surface is partially removed.

Referring to FIG. 15, an average particle removal efficiency of the embodiment where the introduction surface of the gas-liquid contact layer 3 is changed is almost equal to that of the comparative example where the introduction surface of the gas-liquid contact layer 3 is not changed. In this way, in the embodiment where the introduction surface of the gas-liquid contact layer 3 is changed, it may be seen indirectly that even when a part of the fine dust is removed from the discharge surface, re-scattering of fine dust flying again does not occur.

Referring to FIG. 16, the quality factor of the comparative example where the introduction surface of the gas-liquid contact layer 3 is not changed sharply decreases over time, but the quality factor of the embodiment where the introduction surface of the gas-liquid contact layer 3 is changed decreases relatively less. Thus, the embodiment where the introduction surface of the gas-liquid contact layer 3 is changed may more efficiently remove fine dust with less energy than the comparative example where the introduction surface of the gas-liquid contact layer 3 is not changed. This result may be due to a change in the introduction surface of the gas-liquid contact layer 3.

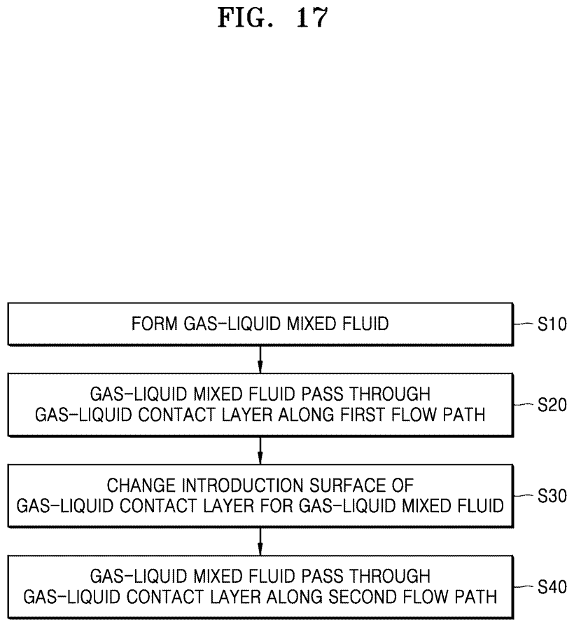

FIG. 17 is a flowchart for describing an air purifying method of an air purifier according to an embodiment.

Referring to FIGS. 1, 5, and 17, an embodiment of the air purifying method may be the air purifying method of the air purifier that collects the fine dust by at least one gas-liquid contact layer 3.

In the air purifying method according to an embodiment, the gas-liquid mixed fluid may be formed by spraying the air containing the fine dust (S10). In an embodiment, the droplet spraying unit 2 may spray the droplets into the duct 1. As the droplets are sprayed, a part of the fine dust contained in the air may be collected and coarsened by the droplets.

The formed gas-liquid mixed fluid may move toward the gas-liquid contact layer 3 along the duct 1. The gas-liquid mixed fluid may flow from the inlet 11 toward the outlet 12 along the duct 1.

A plurality of gas-liquid contact layers 3 may be arranged in the duct 1. As shown in FIG. 5, the plurality of gas-liquid contact layers 3 may be arranged to be spaced apart from each other in a direction perpendicular to the direction of gravity G. The adjacent gas-liquid contact layers 3 among the plurality of gas-liquid contact layers 3 may be arranged in a way such that the first surfaces 301 face each other or the second surfaces 302 face each other. The first channel CH1 may be provided through which the gas-liquid mixed fluid is movable between the first surfaces 301 of the adjacent gas-liquid contact layers 3, and the second channel CH2 may be provided through which the gas-liquid mixed fluid is movable between the second surfaces 302 of the adjacent gas-liquid contact layers 3.

Next, the gas-liquid mixed fluid may pass through the gas-liquid contact layer 3 along any one of the first flow path P1 and the second flow path P2 (S20). In some embodiments, the gas-liquid mixed fluid may pass through the gas-liquid contact layer 3 along the first flow path P1. To allow the gas-liquid mixed fluid to be introduced via the first surface 301, the first channel blocking member 110 may open the upstream side of the first channel CH1 and block the upstream side of the second channel CH2. To allow the gas-liquid mixed fluid to be discharged via the second surface 302, the second channel blocking member 120 may block the downstream side of the first channel CH1 and open the downstream side of the second channel CH2.

The gas-liquid mixed fluid may move along the first flow path P1 along which the gas-liquid mixed fluid is introduced via the first surface 301 of the gas-liquid contact layer 3 and is discharged via the second surface 302, to pass through the gas-liquid contact layer 3. In a process where the gas-liquid mixed fluid is continuously introduced via the first surface 301 of the gas-liquid contact layer 3, the fine dust may be accumulated from the first surface 301.

Next, the introduction surface changing member 100 may change the introduction surface via which the gas-liquid mixed fluid is introduced in the gas-liquid contact layer 3 (S30). In some embodiments, to change the introduction surface via which the gas-liquid mixed fluid is introduced in the gas-liquid contact layer 3 from the first surface 301 to the second surface 302, the position of the introduction surface changing member 100 may be moved. While the position of the introduction surface changing member 100 being moved, the supply of the gas-liquid mixed fluid may be temporarily stopped.

In some embodiments, the first channel blocking member 110 and the second channel blocking member 120 may move in the arrangement direction of the plurality of gas-liquid contact layers 3. The first channel blocking member 110 and the second channel blocking member 120 may move in opposite directions to each other. In some embodiments, as shown in FIG. 8, the first channel blocking member 110 may move to the right, and the second channel blocking member 110 may move to the left.

When the gas-liquid mixed fluid is supplied to the plurality of gas-liquid contact layers 3 in this state, the gas-liquid mixed fluid may be introduced via the second surfaces 302 of the plurality of gas-liquid contact layers 3 through the upstream side of the second channel CH2 and may be discharged via the first surface 301. The gas-liquid mixed fluid discharged via the first surface 301 may be discharged to outside through the upstream side of the first channel CH1. In this process, the gas-liquid mixed fluid may move along the second flow path P2 and pass through the gas-liquid contact layer 3 (S40).

As the gas-liquid mixed fluid moving along the second flow path P2 may be discharged via the first surface 301 of the gas-liquid contact layer 3, at least a part of the pollutant accumulated on the first surface 301 of the gas-liquid contact layer 3 may be removed.

The flow path of the gas-liquid mixed fluid due to the introduction surface changing member 100 may be periodically changed. In some embodiments, the introduction surface may be periodically changed by the introduction surface changing member 100 so that the differential pressure of the gas-liquid contact layer 3 does not depart from a reference range. In some embodiments, the first channel blocking member 110 and the second channel blocking member 120 of the introduction surface changing member 100 may move every specific time.

In an embodiment, as described above, the introduction surface changing member 100 may change the introduction surface from the first surface 301 to the second surface 302, but the introduction surface changing member 100 may alternately and repeatedly change the introduction surface to the first surface 301 or the second surface 302.

According to embodiments of the air purifier and the air purifying method described above, by changing the introduction surface via which the gas-liquid mixed fluid is introduced to the gas-liquid contact layer, a differential pressure rise due to accumulation of the pollutant of the gas-liquid contact layer may be suppressed.

The invention should not be construed as being limited to the embodiments set forth herein. Rather, these embodiments are provided so that this disclosure will be thorough and complete and will fully convey the concept of the invention to those skilled in the art.

While the invention has been particularly shown and described with reference to embodiments thereof, it will be understood by those of ordinary skill in the art that various changes in form and details may be made therein without departing from the spirit or scope of the invention as defined by the following claims.

What is claimed is:

1. An air purifier comprising:
a duct along which air containing fine dust flows;
a droplet spraying unit which sprays droplets into the duct to form a gas-liquid mixed fluid;
a gas-liquid contact layer with a plurality of pores through which the gas-liquid mixed fluid passes, where the gas-liquid contact layer comprises a first surface and a second surface, and the gas-liquid mixed fluid is introduced or discharged via the first and second surfaces; and
an introduction surface changing member which changes an introduction surface of the gas-liquid contact layer, via which the gas-liquid mixed fluid is introduced in the gas-liquid contact layer, from one of the first and second surfaces to the other of the first and second surfaces.

2. The air purifier of claim 1, wherein the introduction surface changing member periodically changes a flow path of the gas-liquid mixed fluid.

3. The air purifier of claim 2, wherein the introduction surface changing member selectively provides: a first flow path along which the gas-liquid mixed fluid is introduced via the first surface of the gas-liquid contact layer and is discharged via the second surface; and a second flow path along which the gas-liquid mixed fluid is introduced via the second surface of the gas-liquid contact layer and is discharged via the first surface.

4. The air purifier of claim 3, wherein the gas-liquid contact layer is provided in plural, and a plurality of gas-liquid contact layers is arranged spaced apart from each other in a direction perpendicular to a direction of gravity.

5. The air purifier of claim 4, wherein adjacent gas-liquid contact layers among the plurality of gas-liquid contact layers are arranged in a way such that first surfaces of the adjacent gas-liquid contact layer face each other or second surfaces of the adjacent gas-liquid contact layer face each other,
a first channel through which the gas-liquid mixed fluid is movable is provided between the first surfaces of the adjacent gas-liquid contact layers, and
a second channel through which the gas-liquid mixed fluid is movable is provided between the second surfaces of the adjacent gas-liquid contact layers.

6. The air purifier of claim 5, wherein the first channel and the second channel are alternately arranged in the direction perpendicular to the direction of gravity.

7. The air purifier of claim 6, wherein when the introduction surface changing member provides the first flow path, the introduction surface changing member allows introduction of the gas-liquid mixed fluid through the first channel, blocks introduction of the gas-liquid mixed fluid through the second channel, allows discharge of the gas-liquid mixed fluid through the second channel, and blocks discharge of the gas-liquid mixed fluid through the first channel, and
when the introduction surface changing member provides the second flow path, the introduction surface changing member allows introduction of the gas-liquid mixed fluid through the second channel, blocks introduction of the gas-liquid mixed fluid through the first channel, allows discharge of the gas-liquid mixed fluid through the first channel, and blocks discharge of the gas-liquid mixed fluid through the second channel.

8. The air purifier of claim 7, wherein the introduction surface changing member comprises:
a first channel blocking member arranged on an upstream side of the plurality of gas-liquid contact layers, wherein the first channel blocking member selectively blocks an upstream side of the first channel or the second channel; and
a second channel blocking member arranged on a downstream side of the plurality of gas-liquid contact layers, wherein the second channel blocking member selectively blocks a downstream side of the first channel or the second channel.

9. The air purifier of claim 8, wherein when the introduction surface changing member provides the first flow path, the first channel blocking member opens an upstream side of the first channel and blocks an upstream side of the second channel to allow introduction of the gas-liquid mixed fluid via the first surfaces and the second channel blocking member blocks a downstream side of the first channel and opens a downstream side of the second channel to allow discharge of the gas-liquid mixed fluid via the second surfaces, and
when the introduction surface changing member provides the second flow path, the first channel blocking member blocks the upstream side of the first channel and opens the upstream side of the second channel to allow introduction of the gas-liquid mixed fluid via the second surfaces and the second channel blocking member opens the downstream side of the first channel and blocks the downstream side of the second channel to allow discharge of the gas-liquid mixed fluid via the first surfaces.

10. The air purifier of claim 8, wherein the first channel blocking member and the second channel blocking member are movable in an arrangement direction of the plurality of gas-liquid contact layers.

11. The air purifier of claim 8, wherein the first channel blocking member and the second channel blocking member move in opposite directions to each other.

12. The air purifier of claim 1, wherein the gas-liquid contact layer comprises a porous foam member.

13. The air purifier of claim 12, wherein a surface of the porous foam member is hydrophobically or hydrophilically treated.

14. The air purifier of claim 1, wherein the gas-liquid contact layer comprises a housing and a plurality of filling particles filled inside the housing.

15. The air purifier of claim 1, comprising a gas removing unit arranged on an upstream side of the droplet spraying unit to remove gaseous pollutants from the air.

16. An air purifying method of an air purifier which collects fine dust through a gas-liquid contact layer, the air purifying method comprising:
spraying droplets to air containing fine dust to form a gas-liquid mixed fluid;
allowing the gas-liquid mixed fluid to move along a first flow path along which the gas-liquid mixed fluid is introduced via a first surface of the gas-liquid contact layer and is discharged via a second surface of the gas-liquid contact layer, to pass through the gas-liquid contact layer;
changing an introduction surface of the gas-liquid contact layer, via which the gas-liquid mixed fluid is introduced in the gas-liquid contact layer, from the first surface to the second surface; and
allowing the gas-liquid mixed fluid to move along a second flow path along which the gas-liquid mixed fluid is introduced via the second surface of the gas-liquid contact layer and is discharged via the first surface, to pass through the gas-liquid contact layer.

17. The air purifying method of claim 16, wherein the changing of the introduction surface comprises moving a position of an introduction surface changing member to change the introduction surface of the gas-liquid contact layer from the first surface to the second surface.

18. The air purifying method of claim 17, wherein the gas-liquid contact layer is provided in plural, and a plurality of gas-liquid contact layers is arranged spaced apart from each other in a direction perpendicular to a direction of gravity,
adjacent gas-liquid contact layers among the plurality of gas-liquid contact layers are arranged in a way such that first surfaces of the adjacent gas-liquid contact layers face each other or second surfaces of the adjacent gas-liquid contact layers face each other,
a first channel through which the gas-liquid mixed fluid is movable is provided between the first surfaces of the adjacent gas-liquid contact layers, and
a second channel through which the gas-liquid mixed fluid is movable is provided between the second surfaces of the adjacent gas-liquid contact layers, and
the introduction surface changing member comprises:
a first channel blocking member arranged on an upstream side of the plurality of gas-liquid contact layers, wherein the first channel blocking member selectively blocks an upstream side of the first channel or the second channel; and
a second channel blocking member arranged on a downstream side of the plurality of gas-liquid contact layers, the second channel blocking member selectively blocks a downstream side of the first channel or the second channel.

19. The air purifying method of claim 18, wherein when the gas-liquid mixed fluid moves along the first flow path, the first channel blocking member opens the upstream side of the first channel and blocks the upstream side of the second channel to allow introduction of the gas-liquid mixed fluid via the first surfaces and the second channel blocking member blocks the downstream side of the first channel and opens the downstream side of the second channel to allow discharge of the gas-liquid mixed fluid via the second surfaces, and
when the gas-liquid mixed fluid moves along the second flow path, the first channel blocking member blocks the upstream side of the first channel and opens the upstream side of the second channel to allow introduction of the gas-liquid mixed fluid via the second surfaces and the second channel blocking member opens the downstream side of the first channel and blocks the downstream side of the second channel to allow discharge of the gas-liquid mixed fluid via the first surfaces.

20. The air purifying method of claim 18, wherein the changing of the introduction surface comprises the first channel blocking member and the second channel blocking member moving in an arrangement direction of the plurality of gas-liquid contact layers.
